(19) United States
(12) Patent Application Publication
(10) Pub. No.: US 2024/0130912 A1
(43) Pub. Date: Apr. 25, 2024

(54) Hyperbaric Chamber with Therapeutic Pressure Control

(71) Applicant: Frederick E. Ryder, Waddell, AZ (US)

(72) Inventor: Frederick E. Ryder, Waddell, AZ (US)

(21) Appl. No.: 17/971,899

(22) Filed: Oct. 23, 2022

(51) Int. Cl. A61G 10/02

(52) U.S. Cl. CPC A61G 10/026; A61G 2203/10; A61G 2203/34

(57) ABSTRACT

The embodied invention is a pressure control system on a hyperbaric chamber where the pressure regulation is automatic, continuous, and independent of the flow curve of the air supply compressor. The chamber is continuously controlled by an air venting control valve with electronic control to provide tight control. The control is able to be programmed to provide a therapeutic, varying pressure for treatment.

### RELATED APPLICATIONS

Not applicable.

### STATEMENT OF GOVERNMENT INTEREST

Not applicable.

### BACKGROUND OF THE INVENTION

### (1) Field of the Invention

This invention is directed to therapeutic hyperbaric chambers which are used in medical treatment.

### (2) Description of Related Art

Hyperbaric therapy involves breathing air or oxygen enriched air in a pressurized chamber. Hyperbaric therapy is a well-known and well-established treatment for decompression sickness, which can occur during scuba diving. A primary medical use for hyperbaric chambers is treating infections and difficult wounds that may not heal due to diabetes or other factors.

In a hyperbaric chamber, the air pressure is increased up to three times higher than normal air pressure for treatment. This allows the blood to absorb more oxygen than would be possible breathing air/enriched air at a normal air pressure. The extra oxygen in the blood is carried throughout a body, aiding in eliminating bacteria and stimulating improved cell growth factors and improved stem cells, which promote healing.

Currently, a common art practice is a completely manual system for pressure control. An air compressor connected to the chamber is turned on, the pressure in the tank rises, and the compressor is turned off once the chamber pressure reaches the pressure treatment amount. However, this method provides no airflow through the chamber during treatment. Consequently, CO₂ will build up inside the tank, and a technician has to sample the tank air to ensure that CO₂ and O₂ are within acceptable limits. If the CO₂ or O₂ levels are out of limit, the inlet and outlet valves are opened, and the air is purged from the tank (i.e. a tank dump.) A more preferred practice is to have a continuous supply of airflow that constantly purges the tank of CO₂ and ensures the correct O₂ level. Currently, an art method for a constant flow utilizes separate vent valves for each desired chamber pressure. This requires the use of 6 to 8 vent valves to cover typical treatment pressures ordered by a doctor. Each vent valve has a shutoff valve which is manually opened. The air compressor is left on during the entire treatment.

Unfortunately, the pressure management can be complicated for technicians to operate. Errors arise if the wrong valve is selected, or if no valve is opened. The number of valves is expensive, and the precise pressure is difficult to monitor when managing multiple hyperbaric chambers.

Hyperbaric treatments that are being developed will require a more automated system. Emerging experimental evidence from small samples supports the concept of a variable pressure treatment due to the way the brain reacts to a changing oxygen amount. An improved endorphin environment is believed to be triggered by the brain when the oxygen level drops, even if the lower amount is well above what the body requires. It would help advance experiments to large trials if the chamber pressure control supports a wide variety of varying pressure curves.

It is important to a patient that the speed of a pressure change is gradual, not instant. It is uncomfortable, even painful, if a rapid pressure change causes pressure to build up behind the ears. To avoid patient complications and complaints, a common art practice is to design the equipment to a ramp up/down pressure of 1 psi per minute. However, patients with ear or eustachian tube infections require a different pressure ramp speed, and the current equipment design make this difficult to achieve. Current manual methods are imprecise and make a controlled ramping rate difficult and time demanding.

What is needed in the art is an improved method to address these issues with an improved control of the chamber pressure:
a continuously purging airflow during treatment
capable of supporting a variety of new treatment methods of that work with the human body to provide better outcomes
capable of variable pressure change rates during treatment
less equipment for improved precision.

### SUMMARY OF THE INVENTION

The embodied invention is a pressure control system on a hyperbaric chamber where the pressure regulation is automatic and continuous. The chamber is continuously controlled by an air venting control valve with electronic control to provide tight control. The control is able to be programmed to provide a therapeutic, varying pressure for treatment. It eliminates

### BRIEF DESCRIPTION OF THE FIGURES

FIG. 1 shows a hyperbaric chamber with pressure control by a pressure venting valve.

FIG. 2 shows the pressure control panel of FIG. 1.

FIG. 3 shows a variable control pressure graph for a therapeutic treatment.

FIG. 4 shows a simplified control panel that creates the variable pressure control of FIG. 3.

FIG. 5 is the control layout inside the microprocessor control panel.

### DETAILED DESCRIPTION OF THE INVENTION

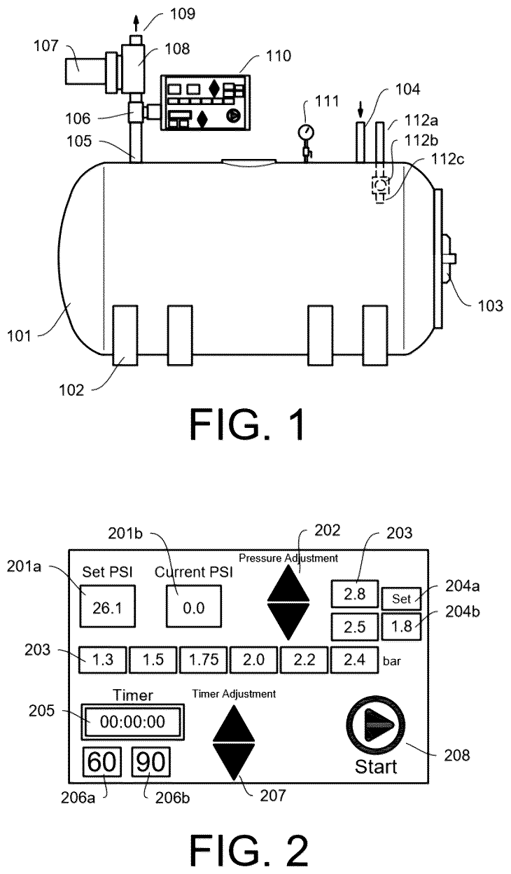

To facilitate the desired improvements, FIG. 1 shows an improved hyperbaric chamber. It is designed to automate the control of pressure by providing an electronic control system to allow the chamber to be run by setpoint. A micro processor controller is located on the chamber, which reduces the cost of the improvement, and lowers installation costs as a separate controller stand is not needed. Once placed in a facility, it can be plugged in and operated.

FIG. 1 shows a Hyperbaric Chamber 101 and feet 102 that support it. An entry door 103 provides access to the chamber by the patient. An air supply connection 104 is used by an air compressor to provide the increased pressure to the chamber. A chamber air vent connection 105 is connected to a venting pressure control valve body 108, and the pressure is monitored by a small piping connection 106 to a control panel 110 where a pressure sensor (not shown) in the control panel provides a pressure signal to a micro controller, which then controls a solenoid 107 the venting valve 108. Chamber pressure is vented through a vent outlet 109. There is a redundant pressure gauge 111 which verifies the pressure readout on the control panel 110. Some treatments require a oxygen input supply 112a with a flow meter 112b, and an inner chamber connection 112c for a patient with a mask or hood. Typically, the supply is 100% oxygen, but mixtures of oxygen/air can also be supplied.

FIG. 2 shows the control panel 110 of FIG. 1. This control panel is set up to control the chamber to a constant therapeutic pressure. A pressure setpoint 201a can be varied according to single preset setpoints 203 or adjusting the setpoint pressure 201a by up/down triangles 202. A readout of the actual chamber pressure 201b provides technician monitoring of the pressure in the chamber. The pressure presets can be adjusted by the preset change button 204a and readout 204b by using up/down pressure triangles 202.

A timer monitors the timed therapeutic session 205 which can be initially set by preset time buttons 206a,b or adjusted to a particular time by the timer adjustment triangles 207. When the both the pressure setpoint and time timer values have been entered, the technician then presses the start button 208 for the treatment to begin.

Initially, the vent control valve is closed and the pressure rises in the chamber. When the pressure setpoint is reached, the venting control valve 108 opens to control pressure. It will continue to open to maintain the pressure setpoint, and the air compressor supply will continue to add air to the chamber based on the air compressor pressure/flow curve. Typically the airflow through the chamber is 3 CFM.

For a therapy session, it is possible to turn off the compressor to save energy, and then the venting valve will close, near the correct pressure setpoint. However, it is preferable to have a continuous flow of air through the chamber to prevent CO₂ buildup. During a therapy session, it is a common practice to use a CO₂ monitor to ensure a safe chamber air. Air compressors are typically controlled in an on/off manner without using a more expensive control system.

The control is capable of being set up based on the elevation above sea level when downloading the operational program into the micro controller in the control panel. Alternately, the electronic pressure gauge can be calibrated at sea level, and the actual pressure is displayed as absolute pressure. For example, the atmospheric pressure at sea level is 14.7 psia, and at 5000 ft in Denver, Colorado it is 12.2 psia.

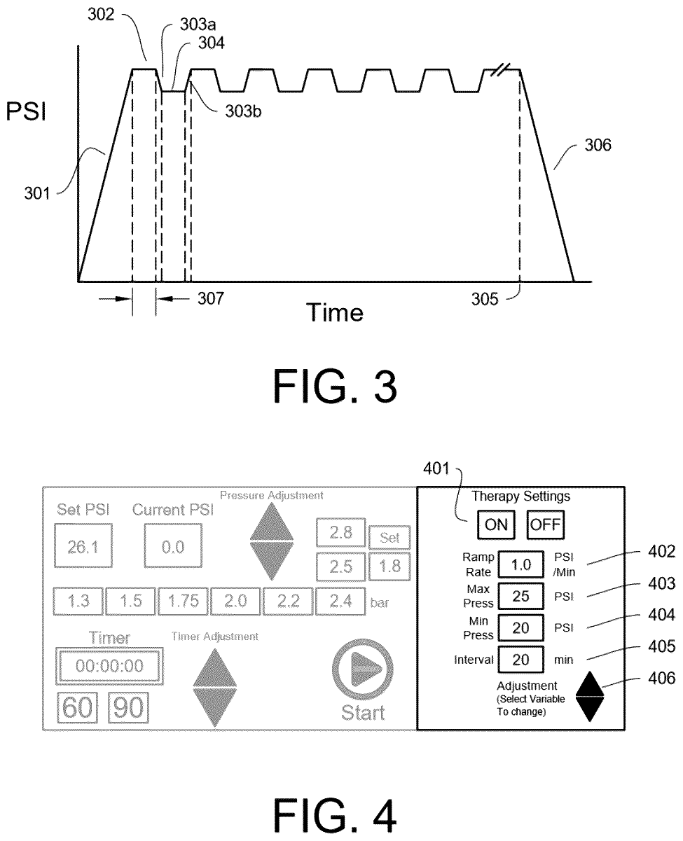

FIG. 3 shows a graph of a varying pressure therapy session. Initially, the air compressor is turned on and the pressure rises 301. The compressor is left on, and the venting valve controls the pressure to an upper treatment pressure 302. This continues for an interval time 307, and then the pressure reduces 303a to a lower treatment pressure 304. This continues for the interval time 307 and then rises 303b to the upper treatment pressure. The session continues with the falling/rising 303a,b between the upper 302 and lower pressures 302, 304 until the end of the therapy timer 305 is reached. The inflow is then stopped by turning off the compressor or closing an inlet valve, and the pressure slowly ramps down 306 to zero.

FIG. 4 shows an addition to the control panel 110 to provide for additional setpoints needed for the therapy session according to FIG. 3. The therapy settings can be flagged to be in an on/off condition 401 by pressing either button. The default is off. The pressure change ramp rate 402, the maximum therapy pressure 403, the minimum therapy pressure 404, the interval time 405, are all adjustable by the up/down triangles 406. To change a setpoint value, the setpoint boxes are pressed which changes color or intensity, indicating that it is ready for a change. When the desired setpoint is reached, the box can be re-selected to lock the number into the micro controller panel memory.

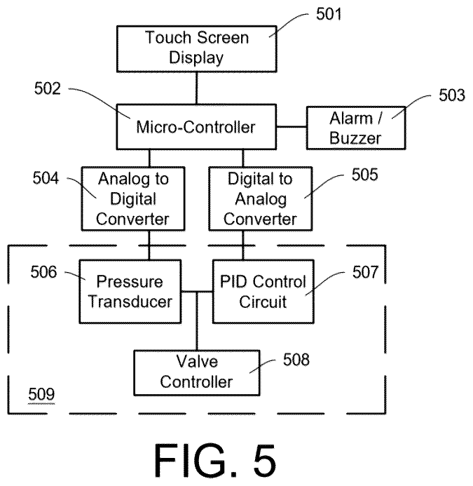

FIG. 5 is a layout of the control panel. The control panel includes a touch screen display 501 with interface which is connected to the micro-controller 502. An alarm buzzer 503 sounds when the program detects a fault or loss of pressure control. It can also make a sound when the desired pressure setpoint is reached. There is an analog to digital converter 504 between the micro-controller and the pressure transducer 506 so the micro-controller reads the value of the chamber pressure, displays it on the touch screen, and monitors it. A digital to analog converter 505 allows the micro-processor to communicate the pressure setpoint to the PID control circuit 507. It also allows control circuit tuning by the micro-processor so that the control circuit is stable. Alternately, the PID control circuit constants may be adjustable digital switches, screw adjustable pots, and the like, depending upon the PID circuit design.

A pressure control system 509 comprises the pressure transducer 506 and the PID control circuit 507 that ultimately instruct the valve controller 508 to obtain and maintain the desired pressure, whether constant or variable.

In the current conceived embodiment of the invention, the rate at which the pressure rises and falls is controlled by a common setpoint in psi/minutes. This is due to body physiology about what a patient can comfortably withstand. Typically, a single rate is sufficient for all rising and falling of pressure, both initially and during the varying upper/lower pressures. However, such a rate is easily adjustable for each place of rising/falling and the embodied invention is capable to readily add a variety of pressure rate setpoints to the control panel.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. A hyperbaric chamber designed to provide a continuously controlled pressure comprising:
A) a hyperbaric chamber connected to a pressurized air supply,
B) a venting control valve connected to said hyperbaric chamber,
C) said venting control valve is controlled by a control panel,
D) said control panel having a variety of setpoints comprising:
a) a chamber pressure setpoint, said chamber pressure setpoint selectable from:
i) a plurality of preset amounts, and
ii) an adjustable pressure amount,
b) a timer setpoint, said timer setpoint selectable from:
i) a plurality of preset amounts,
ii) an adjustable timer amount,
E) said control panel having a start button, and
F) whereby a regulated pressure in said hyperbaric chamber is controlled by said venting control valve.

2. The hyperbaric chamber according to claim 1 further comprising:
A) said venting control valve controlled by said control panel to provide a variable pressure within said hyperbaric chamber, and
B) said variable pressure comprises an upper pressure and a lower pressure defined by a lower pressure setpoint and an upper pressure setpoint within said control panel.

3. The hyperbaric chamber according to claim 2 further comprising:
A) timing of said upper pressure and said lower pressure are maintained by an interval time,
B) said interval time determines how long said upper pressure and said lower pressure are maintained.

4. A method of providing a continuously controlled pressure in a hyperbaric chamber comprising:
A) providing:
a) a hyperbaric chamber connected to a pressurized air supply,
b) a venting control valve connected to said hyperbaric chamber,
c) said venting control valve is controlled by a control panel,
d) said control panel having a variety of setpoints comprising:
i) a chamber pressure setpoint, said chamber pressure setpoint selectable from:
a plurality of preset amounts, and
an adjustable pressure amount,
ii) a timer setpoint, said timer setpoint selectable from:
a plurality of preset amounts, and
an adjustable timer amount,
e) said control panel having a start button, and
B) supplying said pressurized air supply to said hyperbaric chamber, and
C) whereby a regulated pressure in said hyperbaric chamber is controlled by said venting control valve.

5. The method according to claim 4 further comprising:
A) said venting control valve controlled by said control panel to provide a variable pressure within said hyperbaric chamber, and
B) said variable pressure comprises an upper pressure and a lower pressure defined by a lower pressure setpoint and an upper pressure setpoint within said control panel.

6. The hyperbaric chamber according to claim 5 further comprising:
A) timing of said upper pressure and said lower pressure are maintained by an interval time,
B) said interval time determines how long said upper pressure and said lower pressure are maintained.
